(19) United States
(12) Patent Application Publication
(10) Pub. No.: US 2019/0258928 A1
(43) Pub. Date: Aug. 22, 2019

(54) ARTIFICIAL NEURAL NETWORK

(71) Applicant: Sony Corporation, Tokyo (JP)

(72) Inventors: Javier Alonso Garcia, Stuttgart (DE); Fabien Cardinaux, Stuttgart (DE); Thomas Kemp, Stuttgart (DE); Stephen Tiedemann, Stuttgart (DE); Stefan Uhlich, Stuttgart (DE); Kazuki Yoshiyama, Stuttgart (DE)

(73) Assignee: Sony Corporation, Tokyo (JP)

(21) Appl. No.: 16/280,065

(22) Filed: Feb. 20, 2019

(30) Foreign Application Priority Data
Feb. 22, 2018 (EP) 18158172.9

(51) Int. Cl. G06N 3/08; G06N 5/04

(52) U.S. Cl. CPC G06N 3/08; G06N 5/04

(57) ABSTRACT

A computer-implemented method of generating a derived artificial neural network (ANN) from a base ANN comprises initialising a set of parameters of the derived ANN in dependence upon parameters of the base ANN; inferring a set of output data from a set of input data using the base ANN; quantising the set of output data; and training the derived ANN using training data comprising the set of input data and the quantised set of output data.

### CROSS-REFERENCE TO RELATED APPLICATION

The present application claims priority to European Patent Application 18158172.9 filed by the European Patent Office on Feb. 22, 2018, the entire contents of which being incorporated herein by reference.

### BACKGROUND

This disclosure relates to artificial neural networks (ANNs).

So-called deep neural networks (DNN) have become standard machine learning tools to solve a variety of problems such as computer vision and automatic speech recognition processing.

Designing and training such a DNN is typically very time consuming. When a new DNN is developed for a given task, many so-called hyper-parameters (parameters related to the overall structure of the network) must be chosen empirically. For each possible combination of structural hyper-parameters, a new network is typically trained from scratch and evaluated. While progress has been made on hardware (such as Graphical Processing Units providing efficient single instruction multiple data (SIMD) execution) and software (such as a DNN library developed by NVIDIA called cuDNN) to speed-up the training time of a single structure of a DNN, the exploration of a large set of possible structures remains still potentially slow.

It is envisaged that various electronic devices may be equipped with ANN technology. An example is the use of an ANN in a digital camera for techniques such as face detection and/or recognition. It is recognised that a family of devices may use similar techniques but provide different processing capabilities.

### SUMMARY

The present disclosure provides a computer-implemented method of generating a derived artificial neural network (ANN) from a base ANN, the method comprising:

initialising a set of parameters of the derived ANN in dependence upon parameters of the base ANN;

inferring a set of output data from a set of input data using the base ANN;

quantising the set of output data; and

training the derived ANN using training data comprising the set of input data and the quantised set of output data.

The present disclosure also provides computer software which, when executed by a computer, causes the computer to implement the above method.

The present disclosure also provides a non-transitory machine-readable medium which stores such computer software.

The present disclosure also provides an artificial neural network (ANN) generated by the above method and data processing apparatus comprising one or more processing elements to implement such an ANN.

Further respective aspects and features of the present disclosure are defined in the appended claims.

It is to be understood that both the foregoing general description and the following detailed description are exemplary, but are not restrictive, of the present technology.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, in which:

FIG. 1 schematically illustrates an example neuron of an artificial neural network (ANN);

FIG. 2 schematically illustrates an example ANN;

FIG. 3 is a schematic flowchart representing the use of an ANN;

FIG. 4 is a schematic flowchart illustrating a training process;

FIG. 5 schematically illustrates a camera apparatus;

FIG. 6 schematically illustrates a data processing apparatus;

FIG. 7 schematically illustrates a performance adaptation process;

FIG. 8 schematically illustrates a structural adaptation process;

FIG. 9 schematically represents a morphing process;

FIG. 10 schematically represents a base ANN and a modified ANN;

FIG. 11 is a schematic flowchart illustrating a method;

FIGS. 12a to 12d schematically represent example ANNs;

FIG. 13 schematically represents a process to convert a convolutional layer to an Affine layer; and

FIG. 14 is a schematic flowchart illustrating a method.

### DESCRIPTION OF THE PREFERRED EMBODIMENTS

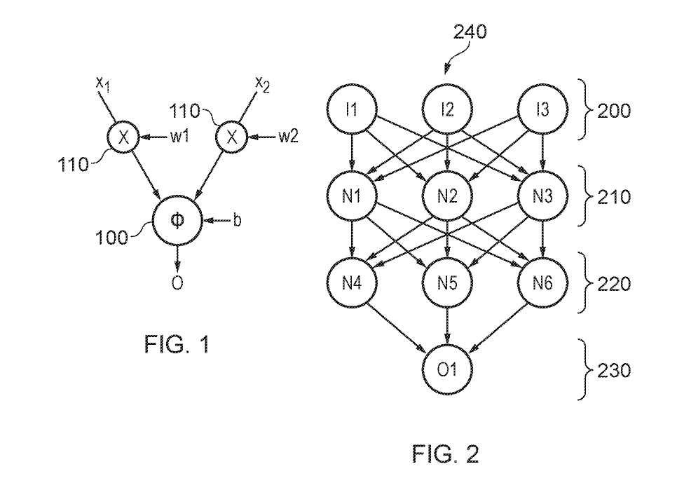

Referring now to the drawings, FIG. 1 schematically illustrates an example neuron 100 of an artificial neural network (ANN). A neuron in this example is an individual interconnectable unit of computation which receives one or more inputs x1, x2 . . . , applies a respective weight w1, w2 . . . to the inputs x1, x2, for example by a multiplicative process shown schematically by multipliers 110 and then adds the weighted inputs and optionally a so-called bias term b, and then applies a so-called activation function ϕ to generate an output O. So the overall functional effect of the neuron can be expressed as:

$$O = f ( {x}_{i} , {w}_{i} ) = φ ( {\sum }_{i}^{ } ( {w}_{i} \cdot {x}_{i} + b ) )$$

Here x and w represent the inputs and weights respectively, b is the bias term that the neuron optionally adds, and the variable i is an index covering the number of inputs (and therefore also the number of weights that affect this neuron).

FIG. 2 schematically illustrates an example ANN 240 formed of an array of the neurons of FIG. 1. The examples shown in FIG. 2 comprises an ordered series of so-called fully-connected or Affine layers 210, 220, preceded by an input layer 200 and followed by an output layer. The fully connected layers 210, 220 are referred to in this way because each neuron N1 . . . N3 and N4 . . . N6 in each of these layers is connected to each neuron in the next layer.

The neurons in a layer have the same activation function ϕ, though from layer to layer, the activation functions can be different.

The input neurons I1 . . . I3 do not themselves normally have associated activation functions. Their role is to accept data from (for example) a supervisory program overseeing operation of the ANN. The output neuron(s) O1 provide processed data back to the supervisory program. The input and output data may be in the form of a vector of values such as:

[x1, x2, x3]

Neurons in the layers 210, 220 are referred to as hidden neurons. They receive inputs only from other neurons and output only to other neurons.

The activation functions is non-linear (such as a step function, a so-called sigmoid function, a hyperbolic tangent (tanh) function or a rectification function (ReLU).)

### Training and Inference

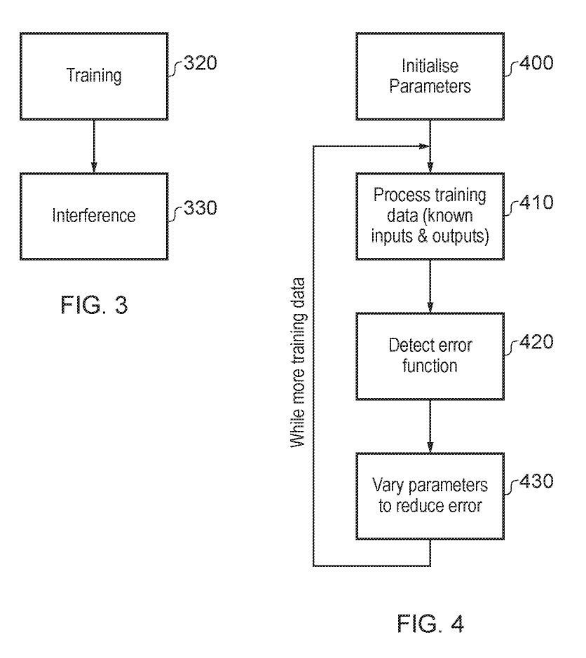

Use of an ANN such as the ANN of FIG. 2 can be considered in two phases, training (320, FIG. 3) and inference (or running) 330.

The so-called training process for an ANN can involve providing known training data as inputs to the ANN, generating an output from the ANN, comparing the output of the overall network to a known or expected output, and modifying one or more parameters of the ANN (such as one or more weights or biases) in order to aim towards bringing the output closer to the expected output. Therefore, training represents a process to search for a set of parameters which provide the lowest error during training, so that those parameters can then be used in an operational or inference stage of processing by the ANN, when individual data values are processed by the ANN.

An example training process includes so-called back propagation. A first stage involves initialising the parameters, for example randomly or using another initialisation technique. Then a so-called forward pass and a backward pass of the whole ANN are iteratively applied. A gradient or derivative of an error function is derived and used to modify the parameters.

At a basic level the error function can represent how far the ANN's output is from the expected output, though error functions can also be more complex, for example imposing constraints on the weights such as a maximum magnitude constraint. The gradient represents a partial derivative of the error function with respect to a parameter, at the parameter's current value. If the ANN were to output the expected output, the gradient would be zero, indicating that no change to the parameter is appropriate. Otherwise, the gradient provides an indication of how to modify the parameter to achieve the expected output. A negative gradient indicates that the parameter should be increased to bring the output closer to the expected output (or to reduce the error function). A positive gradient indicates that the parameter should be decreased to bring the output closer to the expected output (or to reduce the error function).

Gradient descent is therefore a training technique with the aim of arriving at an appropriate set of parameters without the processing requirements of exhaustively checking every permutation of possible values. The partial derivative of the error function is derived for each parameter, indicating that parameter's individual effect on the error function. In a backpropagation process, starting with the output neuron(s), errors are derived representing differences from the expected outputs and these are then propagated backwards through the network by applying the current parameters and the derivative of each activation function. A change in an individual parameter is then derived in proportion to the negated partial derivative of the error function with respect to that parameter and, in at least some examples, having a further component proportional to the change to that parameter applied in the previous iteration.

An example of this technique is discussed in detail in the following publication http://page.mi.fu-berlin.de/rojas/neural/ (chapter 7), the contents of which are incorporated herein by reference.

Training from Scratch

FIG. 4 schematically illustrates an overview of a training process from “scratch”, which is to say where a previously trained ANN is not available.

At a step 400, the parameters (such as W, b for each layer) of the ANN to be trained are initialised. The training process then involves the successive application of known training data, having known outcomes, to the ANN, by steps 410, 420 and 430.

At the step 410, an instance of the input training data is processed by the ANN to generate a training output. The training output is compared to the known output at the step 420 and deviations from the known output (representing the error function referred to above) are used at the step 430 to steer changes in the parameters by, for example, a gradient descent technique as discussed above.

### Training by Adaptation

The technique described above can be used to train a network from scratch, but in the discussion below, techniques will be described by which an ANN is established by adaptation of an existing ANN.

Some reasons for adopting this approach can include the aspect that training an ANN from scratch can be a lengthy and expensive process. In situations where similar but not identical ANNs are required, for example for use in (say) face recognition in a range of relatively similar products such as digital cameras having different respective processing capabilities, training an individual ANN for each model could be prohibitively expensive and/or time consuming. Indeed, it is possible that the original training data may not in fact be available at the time that a new camera model's ANN needs to be trained.

Other reasons can relate to adaptation of an ANN. In the illustrative example of digital cameras, an ANN trained on a brand new and fully operational digital camera may start to become less well suited to that particular camera as the camera ages and (for example) some pixels of an image sensor in the camera potentially deteriorate at different rates, or lens damage affects some parts of the captured images but not others. Here, it could be useful for the ANN to be able to adapt to these changes, but because such an adaptation would be “in the field”, or in other words while the camera is in the hands of the user, the original training data is unlikely to be available.

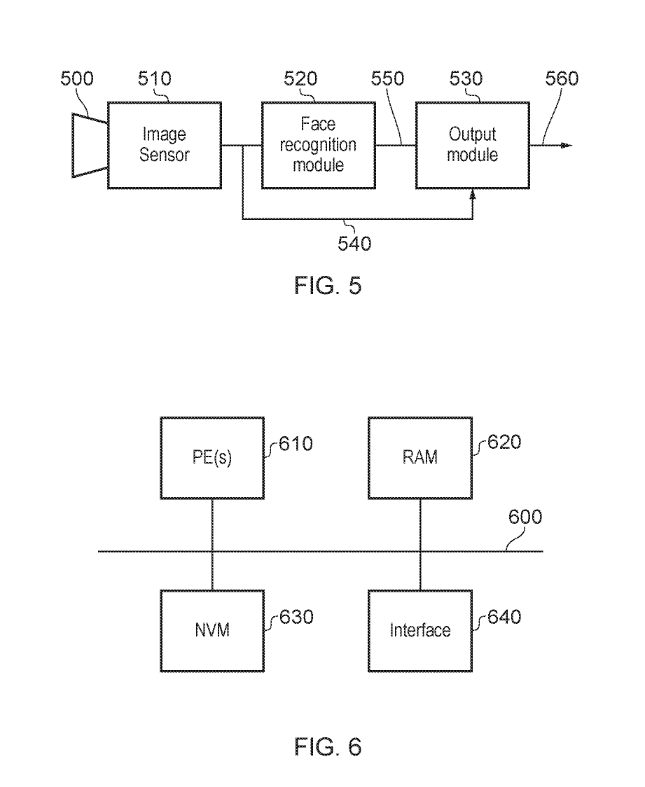

With regard to the context discussed above, FIG. 5 schematically illustrates a digital camera apparatus (purely as an example of an apparatus using an ANN) comprising a lens 500, an image sensor arrangement 510, a face recognition module 520 using an ANN which processes the captured image data 540, and an output module 530 which provides the captured image data 540 and the output 550 of the face recognition module to a user, for example including a display screen (not shown) to display face data along with the captured images and/or a metadata generator (not shown) to add metadata to the captured images as an optional output signal 560.

FIG. 6 schematically illustrates an example data processing apparatus to execute an ANN, for example forming at least a part of the face recognition module 520 of FIG. 5. The data processing apparatus of FIG. 6 is suitable for performing either or both of: performing the training techniques to be discussed below to derive an ANN from a base ANN; and executing the resulting ANN (that is to say, using the resulting ANN in an inference mode). The data processing apparatus comprises a bus structure 600 linking one or more processing elements 610 (such as microprocessors, graphics processing units (CPUs) or the like), a random access memory (RAM) 620, a non-volatile memory 630 such as a hard disk, optical disk or flash memory to store (for example) program code and/or configuration data; and an interface 640, for example (in the case of the apparatus executing the ANN) to interface with a supervisory program.

### Performance Adaptation

One type of adaptation mentioned above is to adapt an existing (base) ANN, running on a particular data processing apparatus, in response to changes in the nature of data being handled by the base ANN. An illustrative example given above relates to deterioration of an image sensor and/or lens in a camera arrangement, but this is just one example. In another illustrative example where the ANN is used for (say) speech recognition, changes over time could occur through the aging of the main user or a geographical move of the apparatus to an area with a different style or accent of speech. This type of adaptation will be referred to in this description as a “performance adaptation”.

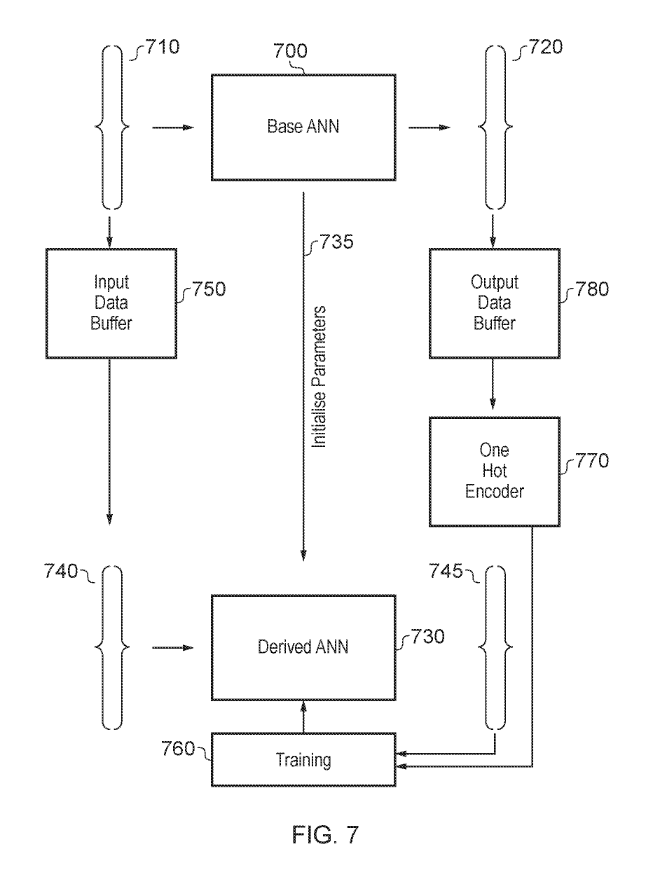

A process for handling such a performance adaptation will be described below with reference to FIG. 7.

FIG. 7 schematically illustrates an already-trained base ANN 700 which, in an inference mode of operation, receives instances 710 of input data (shown schematically as brackets { } to illustrate schematically an instance of an input vector) and generates instances 720 of output data (again represented by vectors { } of multiple data values). The base ANN 700 has been trained so as to have established parameters (such as W, b for each layer) used in the processing of the input data to generate the output data.

The process illustrated in FIG. 7 aims to generate a derived ANN 730 having the same structure as the base ANN (for example, the same number and size of layers), which may be for execution by the same data processing apparatus as the base ANN (this latter feature is not a technical requirement but is likely to be the case in practice).

In brief, the derived ANN is initialised to the same parameters (such as ϕ, W, b for each layer) as those of the base ANN, but is then further trained using input and output data handled by the base ANN, but with the base ANN's output vectors being processed using a quantisation technique such as so-called “one hot” encoding so that the largest single data value of the output vector is set to “1.0” and other data values are set to “0.0”. This is one form of quantisation (other forms can be used) and can serve to reduce errors or uncertainties in the output data from the base ANN and can in at least some situations provide better or more useful data by which the derived ANN can be trained.

As an example, if an output vector 720 as generated by the base ANN is:

[0.2, 0.01, −0.3, 0.8, 0.12, −0.9]

It is quantised by one-hot encoding to:

[0, 0, 0, 1, 0, 0]

Note that typically the output coding is such that negative values correspond to a very low likelihood. Very large magnitude negative values carry the meaning “very close to zero”.

So, referring back to the example training process of FIG. 4 mentioned above, an equivalent of the step 400 is to initialise the derived ANN 730 to have the same initial parameters as those of the base ANN, shown by a schematic arrow 735 in FIG. 7.

The training process corresponding to the step 410 of FIG. 4 is handled by the derived ANN processing input data vectors 740 which have been processed by the base ANN (and which have, for example, been buffered for use in this training process in an input data buffer 750) to generate respective output data vectors 745. These are compared, by training logic 760, with quantised (for example, one-hot encoded) versions (processed by a one-hot encoder 770) of the corresponding one of the base ANN's output data vectors 720. In other words, the quantised output of the base ANN is used as the ground truth training data for the derived ANN. These vectors 720 may have been stored temporarily for this purpose in an output data buffer 780. The training logic 760 undertakes, for example, a gradient descent process to modify the parameters of the derived ANN 730 so that the output 745 of the derived ANN 730 more closely approximates the respective quantised output of the base ANN.

So, in summary, the derived ANN is initialised, for example to be initially identical to the base ANN, and is then trained using actual data processed by the base ANN, with the ground truth output corresponding to that data being taken to be the quantised or one-hot encoded version of the actual output of the base ANN.

In the examples discussed above in which the nature of the input data has potentially changed since the base ANN was first trained, the above process takes this into account by training the derived ANN using actual processed data handled by the base ANN.

In some examples, the process described above can be undertaken by two inter-communicating data processing apparatuses, potentially simultaneously (though this is not a requirement) so that as an input vector is processed by the base ANN, the input and output vectors are passed directly to be used in training the derived ANN. This could in principle avoid the need for the buffers 750, 780.

In other examples, the inference by the base ANN and the training of the derived ANN are executed by the same data processing apparatus on a time division basis, so that the data processing apparatus first executes the base ANN and buffers the input and output data obtained in (for example) a period of normal use. The derived ANN is then trained by the same data processing apparatus using the buffered training data.

In further examples, the inference by the base ANN and the training of the derived ANN are executed, potentially simultaneously, by the same data processing apparatus on a multi-tasking or multi-threading basis.

In summary, in these techniques, the derived ANN may have the same network structure as the base ANN; and the initialising may comprise setting the parameters of the derived ANN to be the same as respective parameters of the base ANN.

### Structural Adaptation

As mentioned above, it may also (or instead) be desirable to adapt the ANN designed for one model of camera and using one configuration of image sensor, lens and face recognition module, for use with another model of camera and using another configuration of image sensor, lens and face recognition module. For example, it may be desired to operate an ANN similar in function to a base ANN but on a data processing apparatus of lower or different computational power than that for which the base ANN was developed. Other examples in apparatuses other than cameras also apply. This type of adaptation will be referred to as a “structural adaptation” in the discussion below.

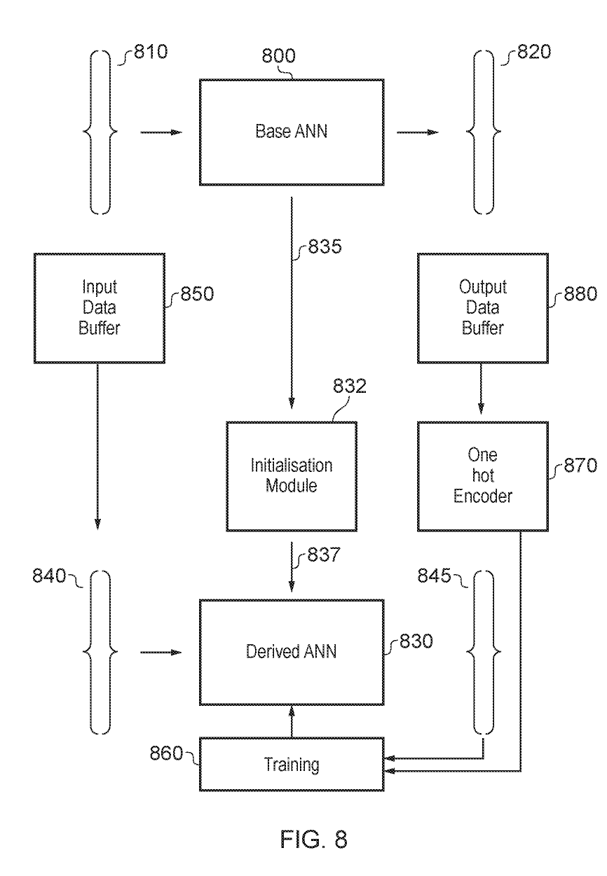

In a structural adaptation, a derived ANN can differ in network structure to the base ANN. An example of this situation is shown schematically in FIG. 8, in which a base ANN 800 is used as the basis for training a derived ANN 830. As before, the base ANN processes input data vectors 810, for example acquired in normal use of the overall apparatus, to generate output data vectors 820. The input and output data vectors may optionally be buffered in respective buffers 850, 880.

The derived ANN has its parameters initialised using those of the base ANN as a starting point. In some instances, it can be possible to omit a layer of the base ANN without change to the non-omitted parameters. In other arrangements however, the initialisation of the parameters of the derived ANN 830 is carried out by an initialisation module 832 which acts on the parameters 835 of the base ANN 800 to generate initialisation parameters 837 for the derived ANN. An example of the performance of this technique (by a so-called least squares method) will be discussed in detail below.

The training process corresponding to the step 410 of FIG. 4 is handled by the derived ANN 830 processing input data vectors 840 which have been processed by the base ANN 800 (and which have, for example, been buffered for use in this training process by the input data buffer 850) to generate respective output data vectors 845. These are compared, by training logic 860, with quantised (one-hot encoded) versions (processed by a one-hot encoder 870) of the corresponding one of the base ANN's output data vectors 820. These vectors 820 may have been stored temporarily for this purpose in the output data buffer 880. The training logic 860 undertakes, for example, a gradient descent process to modify the parameters of the derived ANN 830 so that the output 845 of the derived ANN 830 more closely approximates the respective quantised output of the base ANN.

Therefore, in embodiments, the set of output data comprises one or more output data vectors each having a plurality of data values; and the quantising comprises replacing each data value other than a data value having a highest value amongst the plurality of data values, by a first predetermined value. In for example the quantising process of so-called one-hot encoding, the first predetermined value may be zero. The quantising step may comprise replacing a data value having a highest value amongst the plurality of data values, by a second predetermined value such as 1.

So, in summary, in the structural adaptation case, the derived ANN is initialised, for example using parameters derived from those of the base ANN (for example by the least squares process to be discussed below), and is then trained using actual data processed by the base ANN, with the ground truth output corresponding to that data being taken to be the quantised or one-hot encoded version of the actual output of the base ANN.

### Least Squares Process

Embodiments of the present disclosure can provide techniques to use an approximation method to modify the structure of a previously trained neural network model (a base ANN) to a new structure (of a derived ANN) to avoid training from scratch every time. In the present examples, the previously trained network is the base ANN 800, the new structure is that of the derived ANN 830, and these processes can be performed by the module 832. The possible modifications (of the derived ANN over the base ANN) include for example increasing and decreasing layer size, widen and shorten depth, and changing activation functions.

A previously proposed approach to this problem would have involved evaluating several net structures by training each structure from scratch and evaluating on a validation set. This requires the training of many networks and can potentially be very slow. Also, in some cases only a limited amount of different structure can be evaluated. In contrast, embodiments of the disclosure modify the structure and parameters of the base ANN to a new structure (the derived ANN) to avoid training from scratch every time.

In embodiments, the derived ANN has a different network structure to the base ANN. In examples, the base ANN has an ordered series of two or more successive layers of neurons, each layer passing data signals to the next layer in the ordered series, the neurons of each layer processing the data signals received from the preceding layer according to an activation function and weights for that layer,

the method comprising:

detecting the data signals for a first position and a second position in the ordered series of layers of neurons;

generating the derived ANN from the base ANN by providing an insertion layer of neurons to provide processing between the first position and the second position with respect to the ordered series of layers of neurons of the base ANN; and

initialising at least a set of weights for the insertion layer using a least squares approximation from the data signals detected for the first position and a second position.

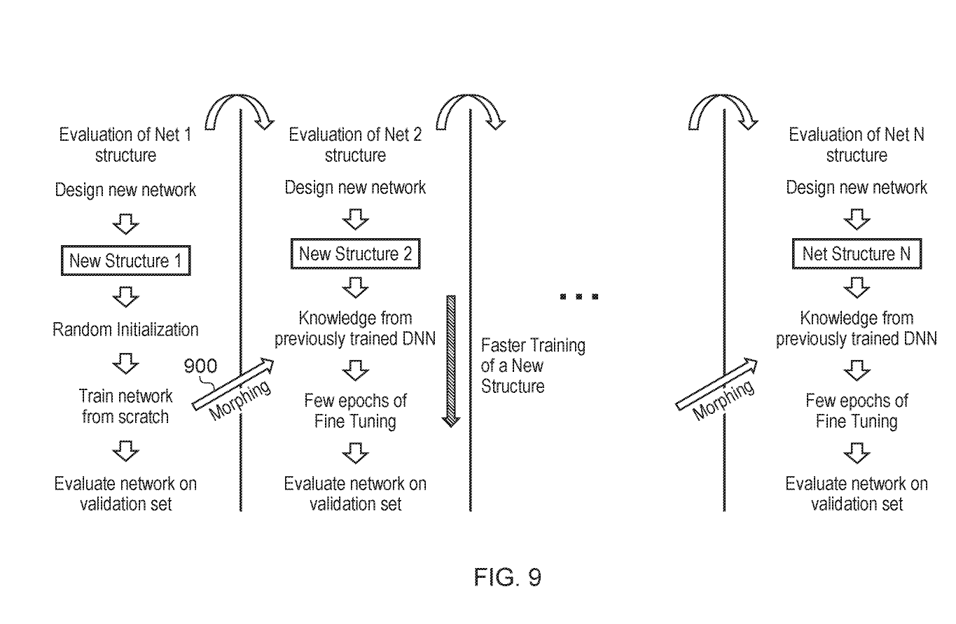

FIG. 9 provides a schematic representation of this process, as applied to a succession of generations of modification. Note that in the arrangement of FIG. 8, only a single generation of modification was considered, but the arrangement of FIG. 8 can be extended to multiple generations each imposing a respective structural adaptation.

In a left hand column of FIG. 9, a first ANN structure (Net 1, which could correspond to the base ANN 800) is prepared, trained and evaluated. A so-called morphing process is used to develop a second ANN (Net 2, which could correspond to the derived ANN 830) as a variation of Net 1. By basing a starting state of Net 2 on the parameters derived for Net1, potentially a lesser amount of subsequent training (using the quantized output of the base ANN) is required to arrive at appropriate weights for Net2. The process can be continued by relatively minor variations and fine-tuning training up to (as illustrated in schematic form) Net N.

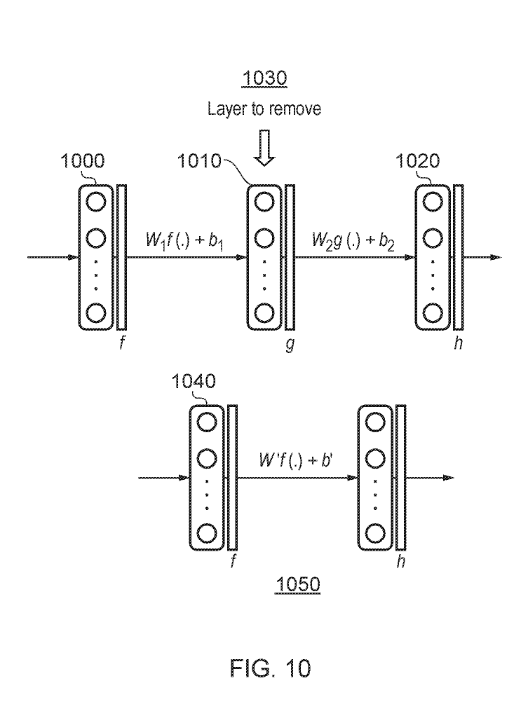

FIG. 10 provides an example arrangement of three layers 1000, 1010, 1020 of an ANN 1030 having associated activation functions f, g, h. In an example of a so-called morphing process to develop a new ANN 1040 from this ANN 1030, the layer 1010 is removed so that the output of the layer 1000 is passed to the layer 1020.

In the present example, the two or more successive layers 1000, 1010, 1020 may be fully connected layers in which each neuron in a fully connected layer is connected to receive data signals from each neuron in a preceding layer and to pass data signals to each neuron in a following layer.

In the present technique, a so-called least squares morphism (LSM) is used to approximate the parameters of a single linear layer such that it preserves the function of a (replaced) sub-network of the parent network.

To do this, a first step is to forward training samples through the parent network up to the input of the sub-network to be replaced, and up to the output of the sub-network. In the example of FIG. 10, the sub-network to be replaced (referred to below as the sub-network) is represented by the layers 1000, 1010, and a replacement layer to replace the function of both of these is represented by a replacement layer 1040 having the same activation function f but different initial weights and bias terms (which are then subject to training in the normal way, for example using the quantized output data of the base ANN as discussed above).

Given the data at the input of the parent sub-network x₁, . . . , x_{N} and the corresponding data at the output of the sub-network y₁, . . . , y_{N} it is possible to approximate (or for example optimize) a replacement linear layer with weights parameters W^{init} and bias term b^{init} which approximate the sub-network. This then provides a starting point for subsequent training of the replacement network (derived ANN) as discussed above. The approximation/optimization problem can be written as:

$$\{ {W}^{init} , {b}^{init} \} = arg {min}_{{W}^{init} , {b}^{init}} {\sum }_{n = 1}^{N} {‖ {y}_{n} - ( {W}^{init T} {x}_{n} + {b}^{init} ) ‖}^{2}$$

The expression in the vertical double bars is the square of the deviation of the desired output y of the replacement layer, from its actual output (the expression with W and b). The sub index n is over the neurons (units) of the layer. So, the sum is something that is certainly positive (because of the square) and zero only if the linear replacement layer accurately reproduces y (for all neurons). So an aim is to minimize the sum, and the free parameters which are available to do this are W and b, which is reflected in the “arg min” (argument of the minimum) operation. In general, no solution is possible that provides zero error unless in certain circumstances; the expected error has a closed form solution and is given below as Jmin.

The solution to this least squares problem can be expressed closed-form and is given by:

$${W}^{init} = {C}_{yx} {C}_{xx}^{- 1} , {b}^{init} = \overline{y} - {W}^{init} \overline{x} , \\ with$$

$${C}_{yx} = {\sum }_{n = 1}^{N} ( {y}_{n} - \overline{y} ) {( {x}_{n} - \overline{x} )}^{T} , \\ {C}_{xx} = {\sum }_{n = 1}^{N} ( {x}_{n} - \overline{x} ) {( {x}_{n} - \overline{x} )}^{T} , \\ and$$

$$\overline{y} = \frac{1}{N} {\sum }_{n = 1}^{N} {y}_{n} , \overline{x} = \frac{1}{N} {\sum }_{n = 1}^{N} {x}_{n} .$$

The residual error is given by:

$${J}_{min} = tr \{ {C}_{tt} - {C}_{tx} {C}_{xx}^{- 1} {C}_{tx}^{T} \} with {C}_{tt} = \frac{1}{K} {\sum }_{k = 1}^{K} ( {t}_{k} - {μ}_{t} ) {( {t}_{k} - {μ}_{t} )}^{T}$$

So, for the replacement layer 1040 of the morphed network (derived ANN) 1050, the initial weights W′ are given by W^{init} and the initial bias b′ is given by b^{init}, both of which are derived by a least squares approximation process from the input and output data (at the first and second positions).

Therefore, in examples, the neurons of each layer of the base ANN process the data signals received from the preceding layer according to a bias function for that layer, the method comprising deriving an initial approximation of at least a bias function for the insertion layer using a least squares approximation from the data signals detected for the first position and a second position.

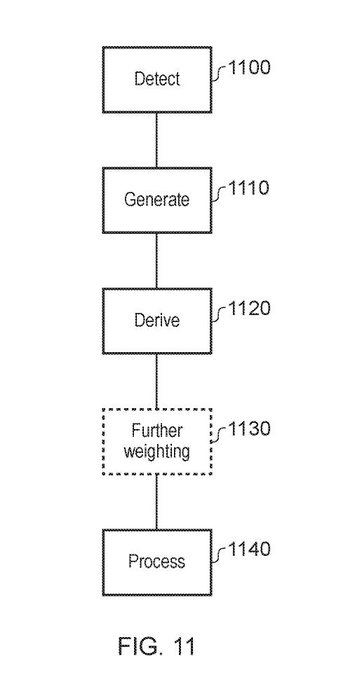

This process of parameter initialisation is summarised in FIG. 11, which is a schematic flowchart illustrating a computer-implemented method of generating a modified or derived artificial neural network (ANN) (such as the modified network 1050 or the derived ANN 830) from a base ANN (such as the base ANN 1030 or 800) having an ordered series of two or more successive layers 1000, 1010, 1020 of neurons, each layer passing data signals to the next layer in the ordered series, the neurons of each layer processing the data signals received from the preceding layer according to an activation function f, g, h and weights W for that layer,

the method comprising:

detecting (at a step 1100) the data signals for a first position x₁, . . . , x_{N} (such as the input to the layer 1000) and a second position y₁, . . . , y_{N} (such as the output of the layer 1010) in the ordered series of layers of neurons;

generating (at a step 1110) the modified ANN from the base ANN by providing an insertion layer 1040 of neurons to provide processing between the first position and the second position with respect to the ordered series of layers of neurons of the base ANN (in the example above, the layer 1040 replaces the layers 1000, 1010 and so acts between the (previous) input to the layer 1000 and the (previous) output of the layer 1010);

deriving (at a step 1120) an initial approximation of at least a set of weights (such as W^{init} and/or b^{init}) for the insertion layer 1040 using a least squares approximation from the data signals detected for the first position and a second position; and

processing (at a step 1140) training data (such as training data generated by the one-hot encoder 870 from output data of the base ANN) using the modified ANN to train the modified ANN including training the weights W′ of the insertion layer from their initial approximation.

In this example, use is made of training data comprising a set of data having a set of known input data and corresponding output data (for example being generated by quantising the base ANN output data as discussed above), and in which the processing step 1140 comprises varying at least the weighting of at least the insertion layer to so that, for an instances of known input data, the output data of the modified ANN is closer to the corresponding known output data. For example, for each instance of input data in the set of known input data, the corresponding known output data may be output data of the base ANN for that instance of input data.

An optional further weighting step 1130 is also provided in FIG. 11 and will be discussed below.

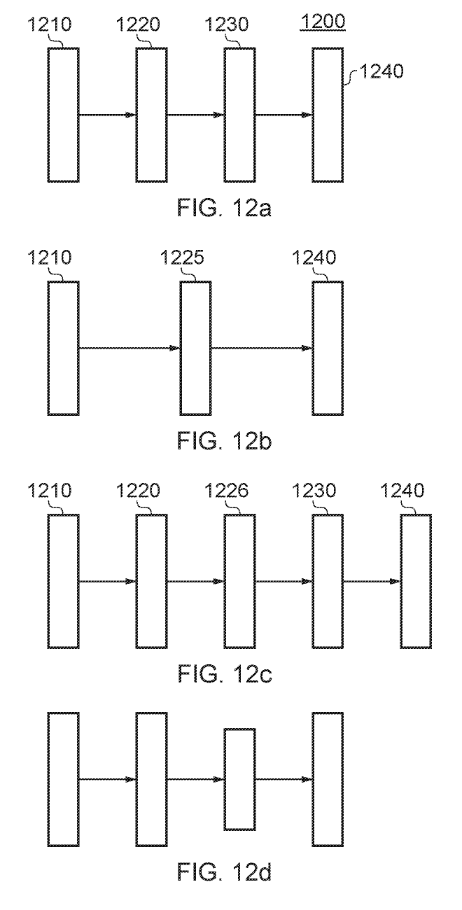

FIGS. 12a-12d schematically illustrate some further example ways in which the present technique can be used to derive a so-called morphed or derived network (such as s next stage to the right in the schematic representation of FIG. 9) from a parent, teacher or base network.

In particular, FIG. 12a schematically represents a base ANN 1200 having an ordered series of successive layers 1210, 1220, 1230, 1240 of neurons, each layer passing data signals to the next layer in the ordered series, the neurons of each layer processing the data signals received from the preceding layer according to an activation function and weights for that layer. Note that an input and output layer and indeed further layers may additionally be provided. So, the arrangement of FIG. 12a does not necessarily represent the whole of the base ANN, but just a portion relevant to the present discussion.

The process discussed above can be used in the following example ways:

FIG. 12b: the layers 1220, 1230 are replaced by a replacement layer 1225. Here, the step 1100 involves detecting data signals (when training data is applied) for a first position x₁, . . . , x_{N} (such as the input to the layer 1220) and a second position y₁, . . . , y_{N} (such as the output of the layer 1230) in the ordered series of layers of neurons; the insertion layer is the layer 1225; and the step 1120 involves deriving an initial approximation of at least a set of weights (W^{init} and/or b^{init}) for the insertion layer 1225 using a least squares approximation from the data signals detected for the first position and a second position. This provides an example of providing the insertion layer to replace one or more layers of the base ANN.

FIG. 12c: a further layer 1226 is inserted between the layers 1220, 1230. Here, the step 1100 involves detecting data signals (when training data is applied) for a first position x₁, . . . , x_{N} (such as the output of the layer 1220) and a second position y₁, . . . , y_{N} (such as the input to the layer 1230) in the ordered series of layers of neurons; the insertion layer is the layer 1226; and the step 1120 involves deriving an initial approximation of at least a set of weights (W^{init} and/or b^{init}) for the insertion layer 1226 using a least squares approximation from the data signals detected for the first position and a second position. This provides an example in which the generating step comprises providing the insertion layer in addition to the layers of the base ANN.

FIG. 12d: the layer 1230 is replaced by a smaller (fewer neurons replacement layer 1227. (In other examples the layer 1227 could be larger; the significant feature here is that it is a differently sized layer to the one it is replacing). Here, the step 1100 involves detecting data signals (when training data is applied) for a first position x₁, . . . , x_{N} (such as the input to the layer 1230) and a second position y₁, . . . , y_{N} (such as the output of the layer 1230) in the ordered series of layers of neurons; the insertion layer is the layer 1227; and the step 1120 involves deriving an initial approximation of at least a set of weights (W^{init} and/or b^{init}) for the insertion layer 1227 using a least squares approximation from the data signals detected for the first position and a second position. This provides an example in which the insertion layer has a different layer size to that of the one or more layers it replaces.

The ANNs of FIGS. 12b-12d, once trained by the step 1140, provide respective examples of a derived artificial neural network (ANN) generated by the method of FIG. 11.

The techniques may be implemented by computer software which, when executed by a computer, causes the computer to implement the method described above and/or to implement the resulting ANN. Such computer software may be stored by a non-transitory machine-readable medium such as a hard disk, optical disk, flash memory or the like, and implemented by data processing apparatus comprising one or more processing elements.

In further example embodiments, when increasing net size (increase layer size or adding more layers), it can be possible to make use of the increased size to make the subnet more robust to noise.

The scheme discussed above for increasing the size of a subnet aims to preserve a subnet's function t:

t=NET(X)=MORPHED_NET(X)

In other examples, similar techniques can be used in respect of a deliberately corrupted outcome, so as to provide a morphed subnet so that:

t=NET(X)≈MORPHED_NET(\tilde{X})

with \tilde{X} being a corrupted version of X.

A way to corrupt \tilde{X} is to use binary masking noise, sometimes known as so-called “Dropout”. Dropout is a technique in which neurons and their connections are randomly or pseudo-randomly dropped or omitted from the ANN during training. Each network from which neurons have been dropped in this way can be referred to as a thinned network. This arrangement can provide a precaution against so-called overfitting, in which a single network, trained using a limited set of training data including sampling noise, can aim to fit too precisely to the noisy training data. It has been proposed that in training, any neuron is dropped with a probability p (0<p<=1). Then at inference time, the neuron is always present but the weight associated with the neuron is modified by multiplying it by p.

Applying this type of technique to the LSM process discussed above (to arrive at a so-called denoising morphing process), as seen previously the least square solution for:

$$\{ W , b \} = arg {min}_{W , b} \frac{1}{2 K} {\sum }_{k = 1}^{K} {‖ {Wx}_{k} + b - {t}_{k} ‖}^{2}$$

$$W = {C}_{tx} {C}_{xx}^{- 1} and b = {μ}_{t} - W {μ}_{x}$$

For the denoising morphing an aim is to optimize:

$$\{ W , b \} = arg {min}_{W , b} \frac{1}{2 K} {\sum }_{k = 1}^{K} {‖ W {\tilde{x}}_{k} + b - {t}_{k} ‖}^{2}$$

where \tilde{x}ₖ is xₖ corrupted by dropout with probability p. The corruption \tilde{x}ₖ depends on a random or pseudo-random corruption, therefore, in some examples the technique is used to produce R repetitions of the dataset with different corruption \tilde{x}_{r,k} so as to produce a large dataset representative of the corrupted dataset. The least squares (LS) problem then becomes:

$$\{ W , b \} = arg {min}_{W , b} \frac{1}{2 KR} {\sum }_{r = 1}^{R} {\sum }_{k = 1}^{K} {‖ W {\tilde{x}}_{r , k} + b - {t}_{k} ‖}^{2}$$

The ideal position is to perform the optimization with a very large number of repetitions R→∞. Clearly in a practical embodiment, R will not be infinite, but for the purposes of the mathematical derivation the limit R→∞ is considered, in which case the solution of the LS problem is:

W=E[C_{t\tilde{x}}]E[C_{\tilde{x}\tilde{x}}]⁻¹

### Construction of E[C_{t\tilde{x}}]:

The coefficients of (tₖ−μₜ)(\tilde{x}ₖ−μₓ)^{T} keep their “non-corrupted” value with a probability of (1−p) or are set to zero.

Therefore, the expected corrupted correlation matrix can be expressed as:

E[C_{t\tilde{x}}]=(1−p)Cₜₓ

### Construction of E[C_{\tilde{x}\tilde{x}}]:

The off-diagonal coefficients of (\tilde{x}ₖ−μₖ)(\tilde{x}ₖ−μₓ)^{T} keep their “non-corrupted” value with a probability of (1−p)² (they are corrupted if any of the two dimension is corrupted).

The diagonal coefficients of (\tilde{x}ₓ−μₖ)(\tilde{x}ₖ−μₓ)^{T} keep their “non-corrupted” value with a probability of (1−p).

Therefore, the expected corrupted correlation matrix can be expressed as:

$${E [ {C}_{\tilde{x} \tilde{x}} ]}_{α , β} = \{ \begin{matrix}{{( 1 - p )}^{2} [ {C}_{xx} ]}_{α , β} & if α \neq β \\ {( 1 - p ) [ {C}_{xx} ]}_{α , β} & if α = β\end{matrix}$$

The optimization is ideally performed with a very large number of repetitions R→∞.

When R→∞ the solution of the LS problem is:

W=E[C_{t\tilde{x}}]E[C_{\tilde{x}\tilde{x}}]⁻¹

By taking (1−p) out, the solution can also be expressed with a simple weighting of Cₓₓ:

W=Cₜₓ(A∘Cₓₓ)⁻¹

with A being a weighting matrix with ones in the diagonal and the off-diagonal coefficients being (1−p).

$$A = ( \begin{matrix}1 & … & ( 1 - p ) \\ ⋮ & ⋱ & ⋮ \\ ( 1 - p ) & … & 1\end{matrix} )$$

Therefore, W and b can be computed in a closed-form solution directly from the original input data xₖ without in fact having to construct any corrupted data \tilde{x}ₖ. This requires a relatively small modification to the LS solution implementation of the network decreasing operation.

This provides an example of the further weighting step 530, or in other words an example of adding a further weighting to the least squares approximation of the weights to simulate the addition of dropout noise in the ANN.

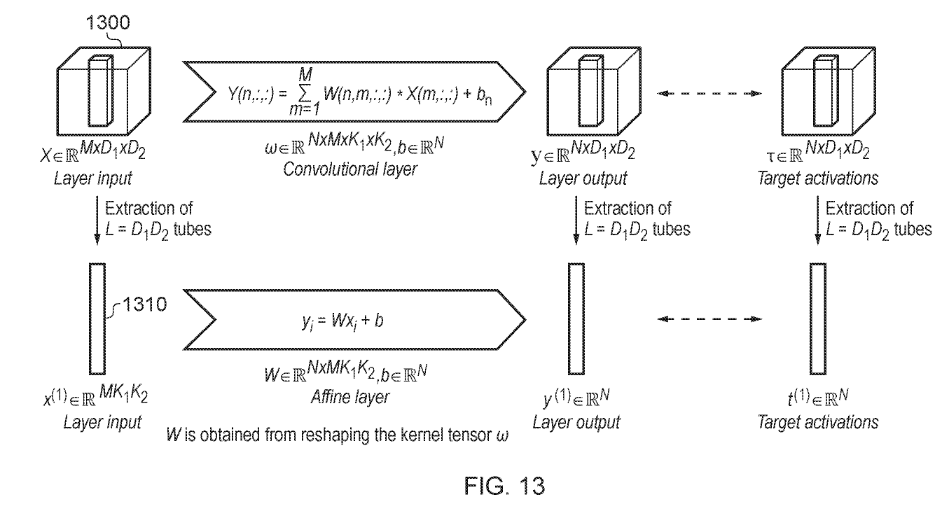

The techniques discussed above relate to fully-connected or Affine layers. In the case of a convolutional layer a further technique can be applied to reformulate the convolutional layer as an Affine layer for the purposes of the above technique. In a convolutional layer a set of one or more learned filter functions is convolved with the input data. Referring to FIG. 13, the paper “From Data to Decisions” (https://iksinc.wordpress.com/tag/transposed-convolution/) which is incorporated in the present description by reference, explains in its first paragraph how a convolution operation can be rewritten as a matrix product. The context here is different but the basic idea is the same: using the same techniques, convolutions can be written as matrix products, and matrix products are affine layers, so, if an affine layer can be morphed and a convolutional layer can be written as an affine, it means it is also possible to morph convolutional layers. Accordingly, a convolutional layer 1300 defined by a set of individual layer inputs x, individual layer outputs y and activations t can be approximated for an Affine layer having a function y=Wx+b by considering the convolutional layer 1300 as a series of so-called “tubes” 1310 linking an input to an output. The resulting Affine layer can then be processed as discussed above.

So, in this example, at least one of the two or more successive layers is a convolutional layer, the method comprising deriving a fully connected layer from the convolutional layer.

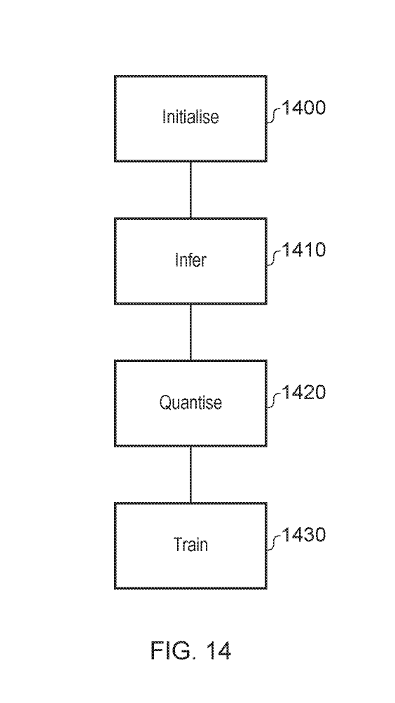

FIG. 14 is a schematic flowchart illustrating a computer-implemented method of generating a derived artificial neural network (ANN) from a base ANN, the method comprising:

initialising (at a step 1400) a set of parameters of the derived ANN in dependence upon parameters of the base ANN;

inferring (at a step 1410) a set of output data from a set of input data using the base ANN;

quantising (at a step 1420) the set of output data; and

training (at a step 1430) the derived ANN using training data comprising the set of input data and the quantised set of output data.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Similarly, a data signal comprising coded data generated according to the methods discussed above (whether or not embodied on a non-transitory machine-readable medium) is also considered to represent an embodiment of the present disclosure.

It will be apparent that numerous modifications and variations of the present disclosure are possible in light of the above teachings. It is therefore to be understood that within the scope of the appended clauses, the technology may be practised otherwise than as specifically described herein.

Various respective aspects and features will be defined by the following numbered clauses:

1. A computer-implemented method of generating a derived artificial neural network (ANN) from a base ANN, the method comprising:

initialising a set of parameters of the derived ANN in dependence upon parameters of the base ANN;

inferring a set of output data from a set of input data using the base ANN;

quantising the set of output data; and

training the derived ANN using training data comprising the set of input data and the quantised set of output data.

2. A method according to clause 1, in which:

the set of output data comprises one or more output data vectors each having a plurality of data values; and

the quantising step comprises replacing each data value other than a data value having a highest value amongst the plurality of data values, by a first predetermined value.

3. A method according to clause 2, in which the first predetermined value is zero.
4. A method according to clause 2 or clause 3, in which the quantising step comprises replacing a data value having a highest value amongst the plurality of data values, by a second predetermined value.
5. A method according to clause 4, in which the second predetermined value is 1.
6. A method according to any one of the preceding clauses, in which:

the derived ANN has the same network structure as the base ANN; and

the initialising step comprises setting the parameters of the derived ANN to be the same as respective parameters of the base ANN.

7. A method according to any one of clauses 1 to 5, in which the derived ANN has a different network structure to the base ANN.
8. A method according to clause 7, in which the base ANN has an ordered series of two or more successive layers of neurons, each layer passing data signals to the next layer in the ordered series, the neurons of each layer processing the data signals received from the preceding layer according to an activation function and weights for that layer,

the method comprising:

detecting the data signals for a first position and a second position in the ordered series of layers of neurons;

generating the derived ANN from the base ANN by providing an insertion layer of neurons to provide processing between the first position and the second position with respect to the ordered series of layers of neurons of the base ANN; and

initialising at least a set of weights for the insertion layer using a least squares approximation from the data signals detected for the first position and a second position.

9. A method according to clause 8, in which the two or more successive layers are fully connected layers in which each neuron in a fully connected layer is connected to receive data signals from each neuron in a preceding layer and to pass data signals to each neuron in a following layer.
10. A method according to clause 8 or clause 9, in which at least one of the two or more successive layers is a convolutional layer, the method comprising deriving a fully connected layer from the convolutional layer.
11. A method according to any one of clauses 8 to 10, in which the training step comprises varying at least the weighting of at least the insertion layer to so that, for an instances of known input data, the output data of the derived ANN is closer to the quantised set of output data.
12. A method according to any one of clauses 8 to 11, in which the generating step comprises providing the insertion layer to replace one or more layers of the base ANN.
13. A method according to clause 12, in which the insertion layer has a different layer size to that of the one or more layers it replaces.
14. A method according to any one of clauses 8 to 13, in which the generating step comprises providing the insertion layer in addition to the layers of the base ANN.
15. A method according to any one of clauses 8 to 14, comprising adding a further weighting to the least squares approximation of the weights to simulate the addition of dropout noise in the ANN.
16. A method according to any one of clauses 8 to 15, in which the neurons of each layer of the base ANN process the data signals received from the preceding layer according to a bias function for that layer, the method comprising deriving an initial approximation of at least a bias function for the insertion layer using a least squares approximation from the data signals detected for the first position and a second position
17. Computer software which, when executed by a computer, causes the computer to implement the method of any one of the preceding clauses.
18. A non-transitory machine-readable medium which stores computer software according to clause 17.
19. An Artificial neural network (ANN) generated by the method of any one of clauses 1 to 16.
20. Data processing apparatus comprising one or more processing elements to implement the ANN of clause 19.

1. A computer-implemented method of generating a derived artificial neural network (ANN) from a base ANN, the method comprising:
initialising a set of parameters of the derived ANN in dependence upon parameters of the base ANN;
inferring a set of output data from a set of input data using the base ANN;
quantising the set of output data; and
training the derived ANN using training data comprising the set of input data and the quantised set of output data.

2. A method according to claim 1, in which:
the set of output data comprises one or more output data vectors each having a plurality of data values; and
the quantising step comprises replacing each data value other than a data value having a highest value amongst the plurality of data values, by a first predetermined value.

3. A method according to claim 2, in which the first predetermined value is zero.

4. A method according to claim 2, in which the quantising step comprises replacing a data value having a highest value amongst the plurality of data values, by a second predetermined value.

5. A method according to claim 4, in which the second predetermined value is 1.

6. A method according to claim 1, in which:
the derived ANN has the same network structure as the base ANN; and
the initialising step comprises setting the parameters of the derived ANN to be the same as respective parameters of the base ANN.

7. A method according to claim 1, in which the derived ANN has a different network structure to the base ANN.

8. A method according to claim 7, in which the base ANN has an ordered series of two or more successive layers of neurons, each layer passing data signals to the next layer in the ordered series, the neurons of each layer processing the data signals received from the preceding layer according to an activation function and weights for that layer,
the method comprising:
detecting the data signals for a first position and a second position in the ordered series of layers of neurons;
generating the derived ANN from the base ANN by providing an insertion layer of neurons to provide processing between the first position and the second position with respect to the ordered series of layers of neurons of the base ANN; and
initialising at least a set of weights for the insertion layer using a least squares approximation from the data signals detected for the first position and a second position.

9. A method according to claim 8, in which the two or more successive layers are fully connected layers in which each neuron in a fully connected layer is connected to receive data signals from each neuron in a preceding layer and to pass data signals to each neuron in a following layer.

10. A method according to claim 8, in which at least one of the two or more successive layers is a convolutional layer, the method comprising deriving a fully connected layer from the convolutional layer.

11. A method according to claim 8, in which the training step comprises varying at least the weighting of at least the insertion layer to so that, for an instances of known input data, the output data of the derived ANN is closer to the quantised set of output data.

12. A method according to claim 8, in which the generating step comprises providing the insertion layer to replace one or more layers of the base ANN.

13. A method according to claim 12, in which the insertion layer has a different layer size to that of the one or more layers it replaces.

14. A method according to claim 8, in which the generating step comprises providing the insertion layer in addition to the layers of the base ANN.

15. A method according to claim 8, comprising adding a further weighting to the least squares approximation of the weights to simulate the addition of dropout noise in the ANN.

16. A method according to claim 8, in which the neurons of each layer of the base ANN process the data signals received from the preceding layer according to a bias function for that layer, the method comprising deriving an initial approximation of at least a bias function for the insertion layer using a least squares approximation from the data signals detected for the first position and a second position

17. Computer software which, when executed by a computer, causes the computer to implement the method of claim 1.

18. A non-transitory machine-readable medium which stores computer software according to claim 17.

19. An Artificial neural network (ANN) generated by the method of claim 1.

20. Data processing apparatus comprising one or more processing elements to implement the ANN of claim 19.
